(19) United States
(12) Patent Application Publication
(10) Pub. No.: US 2018/0016834 A1
(43) Pub. Date: Jan. 18, 2018

(54) SYSTEM, APPARATUS AND METHOD FOR OPENING OR CLOSING A WINDOW

(71) Applicant: BENZION WISLICKI, BROOKLYN, NY (US)

(72) Inventor: BENZION WISLICKI, BROOKLYN, NY (US)

(21) Appl. No.: 15/651,016

(22) Filed: Jul. 17, 2017

Related U.S. Application Data
(60) Provisional application No. 62/362,664, filed on Jul. 15, 2016.

(51) Int. Cl. E06B 9/02; E06B 9/00; E05F 15/00

(52) U.S. Cl. CPC E05F 15/50; E06B 9/02; E05Y 2900/148; E05F 15/00; E06B 9/00

(57) ABSTRACT

A system can be configured to move at least a portion of a window be positioned within a casing in an opening of a wall. The system can include at least one cylinder having a piston. The cylinder can be at least partially concealed within at least one of the wall proximate the window and the casing of the window. At least one valve can be operatively connected to the piston. At least one power supply can be operatively connected to the at least one valve. The power supply can be spaced-apart from the window to reduce or eliminate noise produced by the power supply in a vicinity of the window. At least one controller can be operatively connected to the at least one valve.

### CROSS-REFERENCE TO RELATED APPLICATIONS

The present application claims priority to U.S. Provisional Application No. 62/362,664, filed Jul. 15, 2016 and entitled “System, Apparatus and Method for Opening or Closing a Window,” which is herein incorporated by reference in its entirety.

### BACKGROUND

Windows, such as those in a residential or a commercial building, are often difficult to access. The location of the window or the positioning of furniture near the window may require an individual to stand or kneel, for example, on a couch, bed or desk to open or close the window. Other windows may require an individual to lean or reach over a table or chair to open or close. In addition, some windows can be relatively heavy, and, therefore, be difficult to open. Even if the individual is able to contort oneself to reach the window, the individual then may need to strain simply to open or close the window. The above-described process can damage furniture or the window, and creates the potential of causing injury to the individual. This process can also be time-consuming and frustrating to the individual. Furthermore, certain individuals may find it difficult to open or close even accessible or adjustable windows, such as the elderly or those with disabilities.

### BRIEF SUMMARY

In one embodiment, the present disclosure is directed to a system configured to move at least a portion of a window. The window can be positioned within a frame or casing mounted in an opening of a wall. The system can include at least one cylinder having a piston therein. The cylinder can be at least partially concealed within at least one of the wall proximate the window and the casing. At least one valve can be operatively connected to the piston. At least one power supply can be operatively connected to the piston. The power supply can be spaced-apart from the window to reduce or eliminate noise produced by the power supply in a vicinity of the window. At least one controller can be operatively connected to the at least one valve.

In another embodiment, the present disclosure is directed to a system configured to move at least a portion of a window, the window being positioned within a casing mounted in an opening of a wall. The system can include two spaced-apart actuators. Each actuator can include a cylinder having a piston. The piston can be movable with respect to the cylinder. The cylinder can be at least partially concealed within at least one of the casing and the wall proximate the window. Each cylinder can have a longitudinal axis extending parallel to sidewalls of the window. The system can include at least one solenoid valve operatively connected to each actuator and at least one power supply operatively connected to the at least one solenoid valve. The power supply can be spaced-apart from the window to eliminate or at least reduce noise produced by the power supply in a vicinity of the window. The system can include at least one controller operatively connected to the at least one solenoid valve. The controller can be configured to control operation of at least the valve to thereby control operation of the actuator to move at least a portion of the window. The system can include at least one safety limit switch and at least one photoelectric sensor. The safety limit switch and the photoelectric sensor can be configured to detect obstructions within a zone inside the window.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a schematic diagram of one embodiment of the presently disclosed technology, wherein a window is shown in a closed configuration and two spaced-apart cylinders are shown in a compact configuration;

FIG. 2 is a perspective view of the window used in the embodiment of FIG. 1, wherein the window is shown in an open configuration;

FIG. 3 is a schematic diagram of another embodiment of the presently disclosed technology, wherein a window is shown in a closed configuration and a single cylinder is shown in a compact configuration;

FIG. 4 is an interior perspective view of the window used in the embodiment of FIG. 3, wherein the window is shown in an open configuration;

FIG. 5 is another interior perspective view of the window used in the embodiment of FIG. 3, wherein the window is shown in a closed configuration;

FIG. 6 is an exterior perspective view of the window used in a slightly modified version of the embodiment of FIG. 3, wherein the window is shown in an open configuration and a single cylinder is shown in an expanded configuration;

FIG. 7 is a schematic diagram of a further embodiment of the present disclosure, which is a combination of earlier embodiments described herein;

FIG. 8 is a schematic diagram of a computing system of one embodiment of the present disclosure;

FIG. 9 is a schematic diagram of an actuator of one embodiment of the present disclosure;

FIG. 10 is a schematic diagram of a valve of one embodiment of the present disclosure;

FIG. 11 is an exterior perspective view of the window used in a slightly modified version of the embodiment of FIG. 6, wherein the window is shown in a closed configuration.

### DETAILED DESCRIPTION OF THE INVENTION

Certain terminology is used in the following description for convenience only and is not limiting. The words “bottom,” “top,” “left,” “right,” “lower” and “upper” designate directions in the drawings to which reference is made. Unless specifically set forth herein, the terms “a,” “an” and “the” are not limited to one element but instead should be read as meaning “at least one.” The terminology includes the words noted above, derivatives thereof and words of similar import.

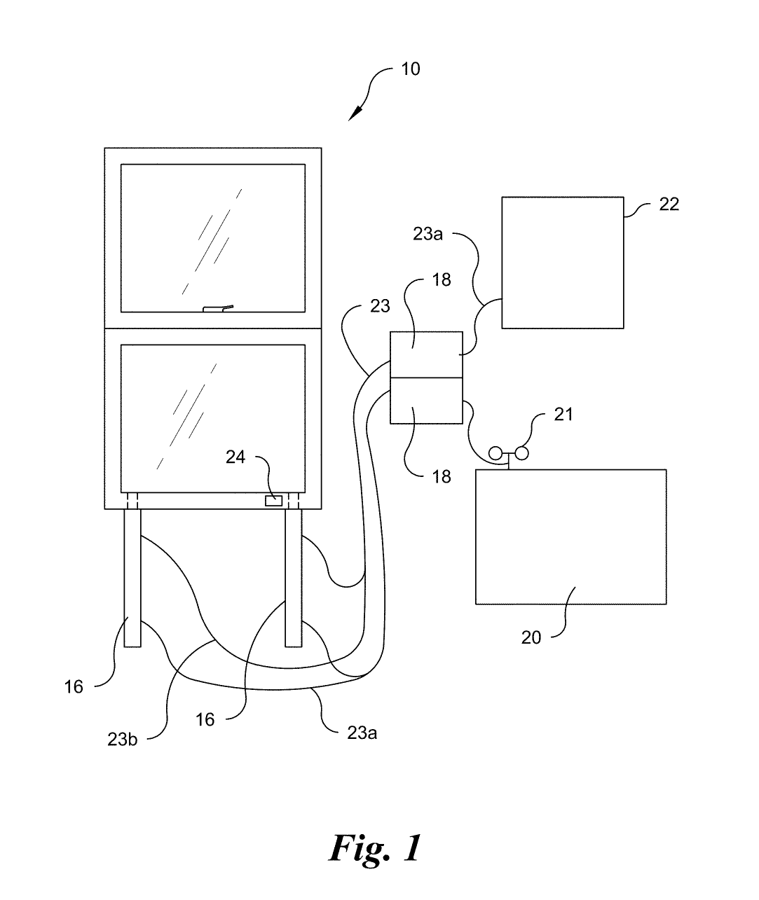

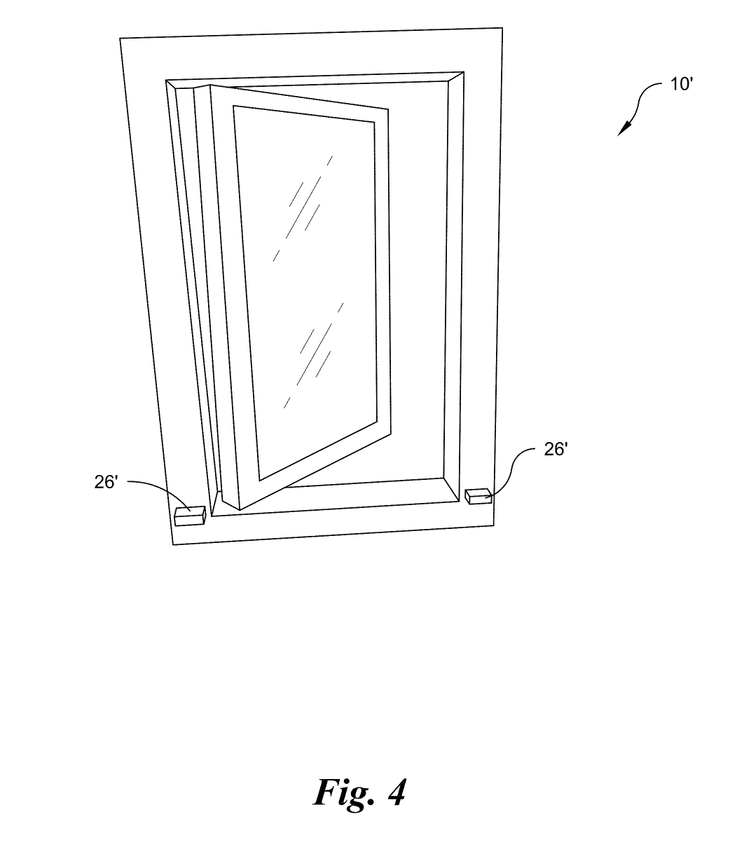

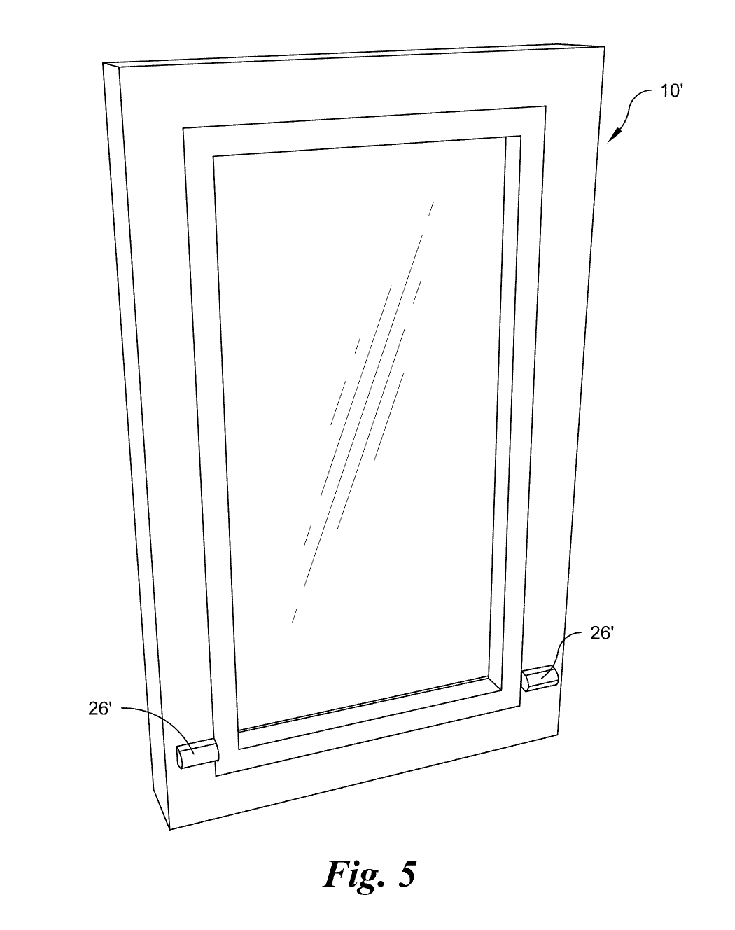

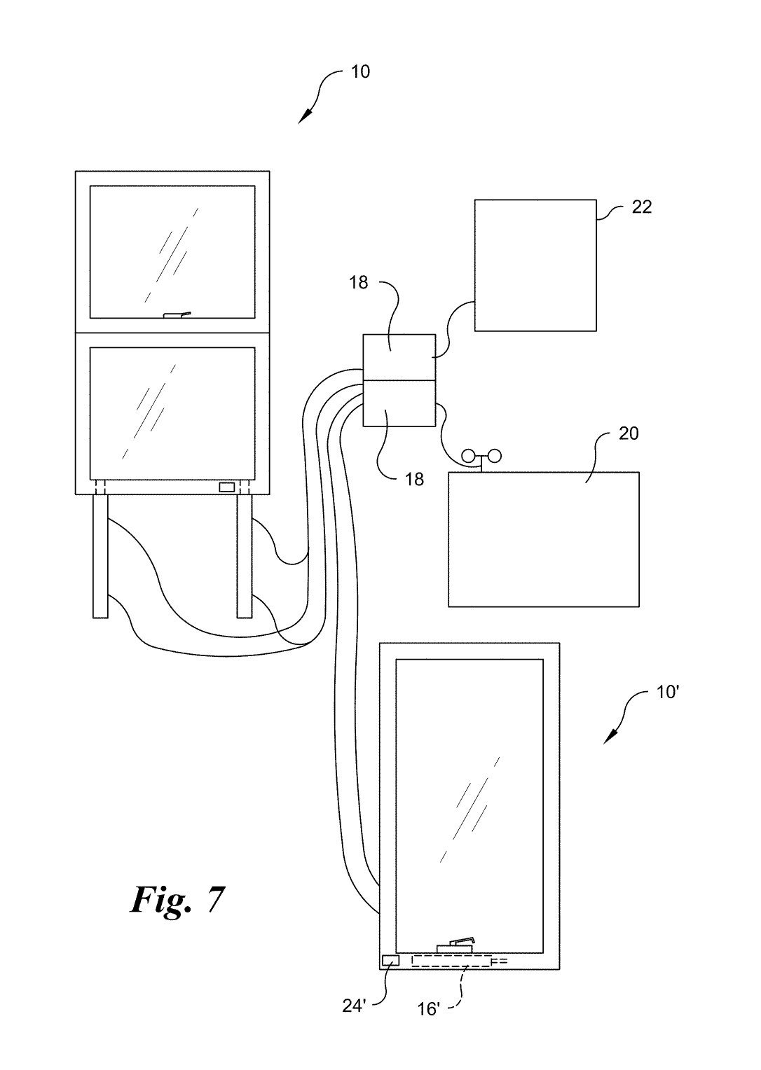

Referring to the drawings in detail, wherein like numerals indicate like elements throughout, FIGS. 1-11 illustrate systems, apparatuses and methods configured to move (e.g., open or close) at least a portion of one or more windows 10, 10′. Each window 10, 10′ can be positioned within a frame or casing 12, 12′ mounted in or secured to an opening of a wall 14, 14′. More particularly, the systems, apparatuses and methods of the presently disclosed invention are configured to open and/or close one or a plurality of windows, from a remote location or a location spaced-apart from the windows, in an easy, convenient and generally labor-free manner.

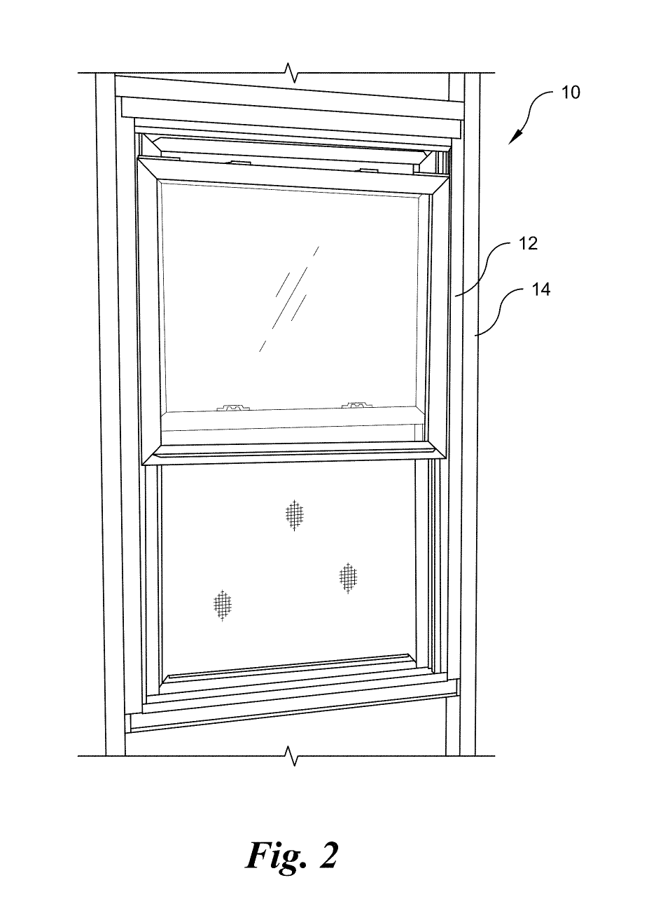

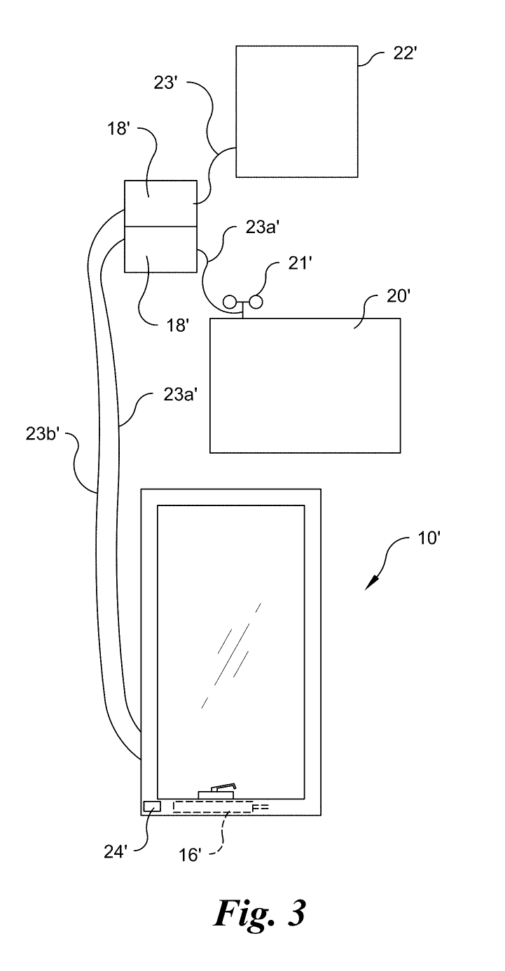

The technology of the presently disclosed invention is not limited to a particular type of window. For example, a first portion of a window can be moved, lifted or pushed with respect to a second portion of the window. Alternatively, a first portion of a window can be pulled with respect to a second portion of the window. Stated differently, each window 10, 10′ can be a single hung window, a double hung window or a sliding or casement window. The window(s) 10, 10′ can be manual or crank operated. FIGS. 1 and 2 show the technology of the presently disclosed invention employed in a double hung window 10. A “double hung window” is broadly defined herein as any window having two operating sashes that move up and down allowing for ventilation on the top, bottom or both. FIGS. 3-6 show the technology of the presently disclosed invention employed in a casement window 10′. In one embodiment, a “casement window” is broadly defined herein as any window having a hinge on one vertical side, wherein the sash opens horizontally opposite the hinge. The term “casement window” can also include a window with hinges on one horizontal edge, such as the top or bottom, and can be pushed or pulled in or out to open or close the window. In such an embodiment, the position of the casement window can be held with friction. A casement window allows for full ventilation from top to bottom of the window opening. The extended sash of a casement window can catch the breeze and direct it into the house, for example, for improved air flow.

In one embodiment, the technology is an aftermarket, electrically powered, pneumatic system that can be operated from a wall-mounted or tabletop switch, a computer, or a handheld remote control, such as through a smartphone software application. In an embodiment encompassing a remote control, the control panel can be wall-mounted. The technology can be particularly helpful to the elderly or the disabled, who may be unable to open and/or close windows manually, as well as to individuals seeking more convenience and less labor in opening or closing windows. The system can be used to open windows locally and/or remotely.

Referring to FIGS. 1, 3 and 6, at least one cylinder 16, 16′ containing a piston can be operatively connected to at least a portion of the window 10, 10′ that is desired to be opened and/or closed. In one embodiment, the cylinder 16, 16′ can be a stock item from suppliers like ADC and McMaster. The cylinder(s) 16, 16′ employed with the presently disclosed technology can be selected or desirable because their size, stroke length and/or pressure rating, for example, making them suitable for the task. Different sized windows can warrant different sizes or different stroke length so as to efficiently execute the command without interfering, or obstructing the opening. In one embodiment, the cylindrical(s) 16, 16′ shape can be the simple model from most suppliers. Alternatively, the cylinder(s) 16, 16′ can have squared or rectangular pistons for heavy duty, or harsh conditions, which can be a better fit in some applications.

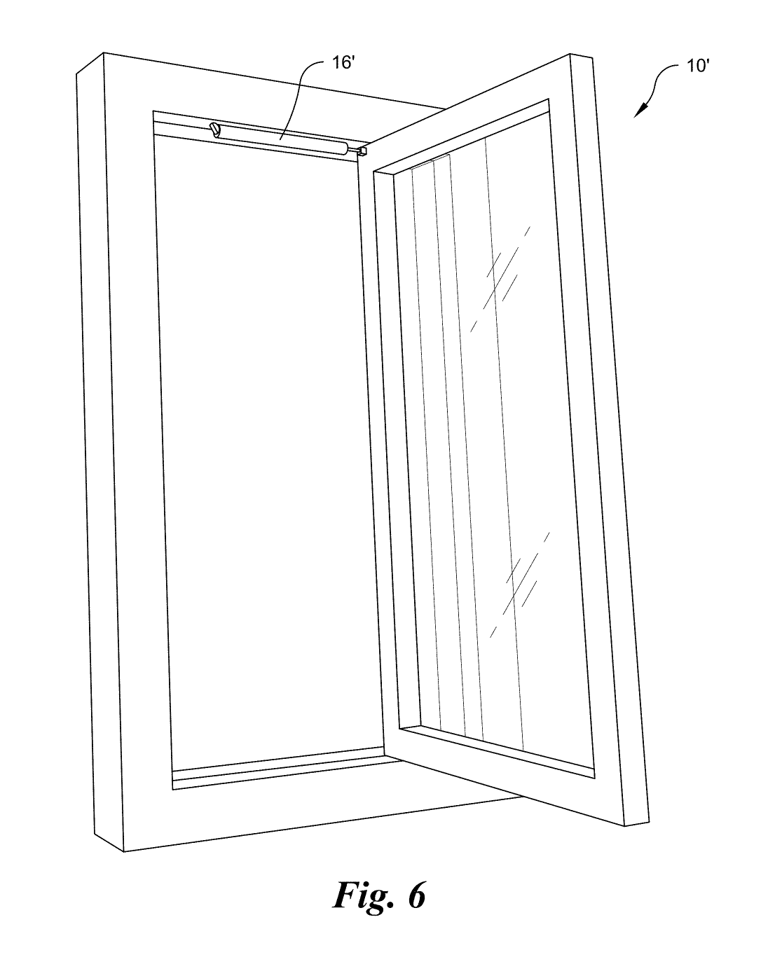

In a double-hung window embodiment, a pair or two-spaced-apart cylinders 16, 16, each containing a piston, can be operatively connected to the portion of the window 10 that is desired to be opened and/or closed. In a casement window embodiment, a single cylinder 16′ containing a piston can be positioned in or near a lower end of the casing 12′ (see FIG. 3) or an upper end of the casing 12′ (see FIG. 6). In FIG. 6, the cylinder 16′ can be configured to retract to pull the window 10′ open, while the cylinder 16′, when extended, can push the window 10′ closed. Alternatively, the cylinder 16′ can be configured to be extended to push the window 10′ open, and the cylinder 16′ can be configured to retract to pull the window 10′ closed.

The technology of the present disclosure is not limited to a particular type of piston. For example, each piston can be a pneumatic piston or a hydraulic piston. Pneumatic cylinders can be beneficial to avoid bulky motor heads and the like near the windows 10, 10′. In an alternative embodiment, the cylinder 16, 16′ can be a rotating actuator (see FIG. 11). The actuator can rotate a crank, such as a manual crank, of a casement window to open and/or close the window.

Each cylinder 16, 16′ can be at least partially or completely concealed within at least one of the wall 14, 14′ proximate the window 10, 10′ and/or the casing 12, 12′. This can be beneficial so as not to obstruct the opening of the window 10, 10′ and to hide unsightly mechanical equipment or features. When the piston is at least partially extended from each cylinder 16, 16′, to at least partially open the respective window 10, 10′, at least a portion of the piston can be visible. Alternatively, when the piston is at least partially extended from each cylinder 16, 16′, to at least partially open the respective window 10, 10′, the entirety of the piston can be concealed from sight, such as within the wall 14, 14′ proximate to the window 10, 10′ and/or the casing 12, 12′.

Each cylinder 16, 16′ can have a first or upper end and a second or lower end. A longitudinal axis can extend from the first to the second ends. The longitudinal axis of each cylinder 16, 16′ can extend generally, if not exactly, parallel to both the sidewalls of the window (e.g., see FIG. 1) and/or the direction to which the portion of the window 10, 10′ is opened and/or closed (e.g., see FIGS. 3 and 6). In one embodiment, each cylinder 16 can be mounted beneath and connected to a lower sash of the window 10. In another embodiment, the cylinder 16′ can be mounted above or below the window 10′, or within a frame of the window 10′ but toward an upper end of the window 10′ or toward a lower end of the window 10′.

In the double-hung window embodiment, each of the two cylinders 16 should be extended at least generally, if not exactly, simultaneously to open at least a portion of the window 10. Similarly, each of the two pistons 16 should be retracted within each cylinder 16 at the same rate, thereby pulling at least a portion of the window 10 closed and/or allowing the portion of the window 10 to close based on gravity. The pistons 16 can be powered by the same valve (as described below), thereby allowing for or creating the simultaneous motion. Operating the cylinders 16 at different rates or at different times could cause the window to jam or become stuck.

When the window 10, 10′ is in a closed position and/or in at least a partially open position, each cylinder 16, 16′ and piston can be entirely or at least partially concealed within at least a portion of the wall 14, 14′ proximate to the window 10, 10′ and/or the casing 12, 12′ of the window 10, 10. Alternatively, when the window 10, 10′ is at least partially open, each cylinder 16 and piston can be partially concealed within at least one of the wall 14, 14′ proximate to the window and the casing 12, 12′ of the window 10, 10′. In such an alternative embodiment, when the window 10, 10′ is at least partially open, a portion of each cylinder 16 and/or piston may be visible or exposed. Stated differently, when the piston is extended (at least partially) from within the cylinder 16, 16′, the window 10, 10′ can be at least partially open. When the piston is fully positioned within the cylinder 16, 16′, the window 10, 10′ can be fully closed.

At least one valve 18, 18′ can be operatively connected to the cylinder 16, 16′. The at least one valve 18, 18′ can help control operation of the cylinder(s) 16, 16′, and thereby help control operation of the window 10, 10′. The valve 18, 18′ is not limited to a particular style, type, and/or configuration. In one embodiment, the valve 18, 18′ can be an electromechanically-operated or solenoid valve. The valve 18, 18′ can be electromechanically operated valve, as described in further detail below. More specifically, the valve 18, 18′ can be controlled by an electric current through a solenoid. For example, in a two-port valve, the flow can be switched “on” or “off.” In a three-port valve, the outflow can be switched between two outlet ports. If necessary or desired, multiple solenoid valves can be placed together on a manifold.

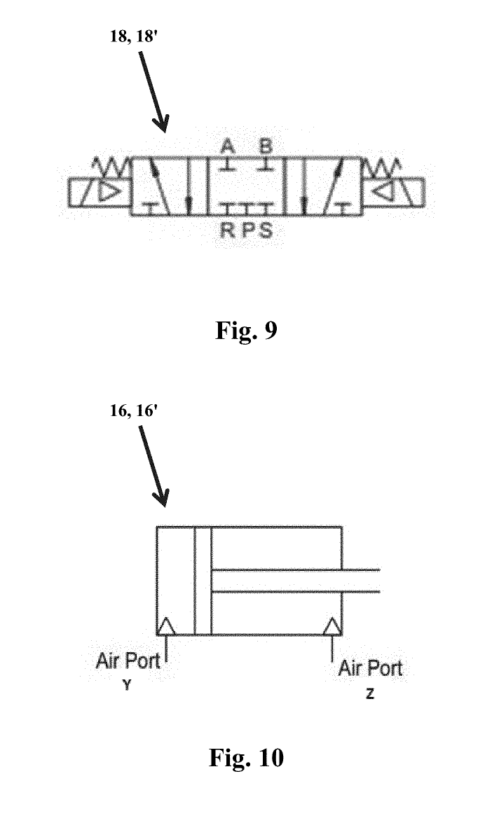

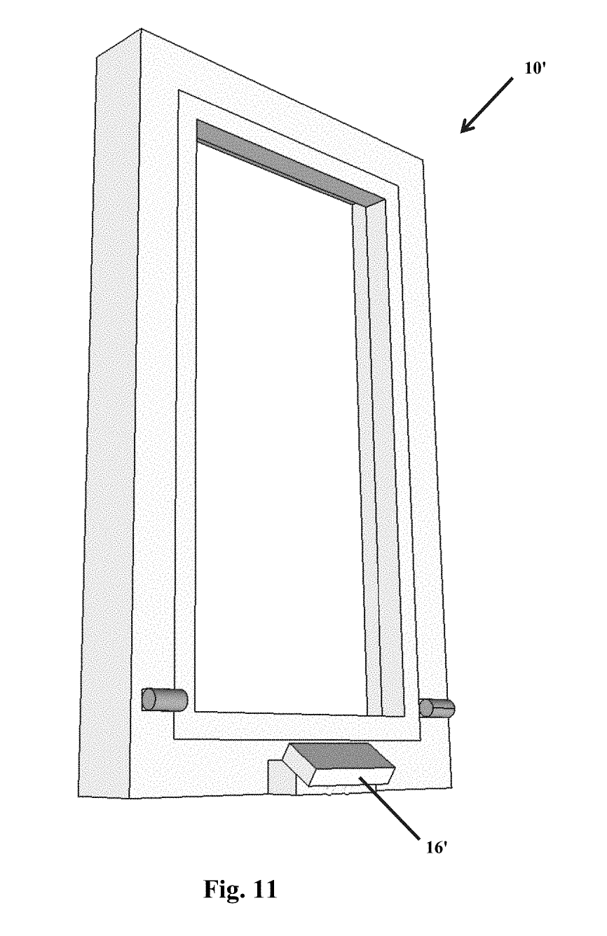

As shown in FIG. 9, each valve 18, 18′ can be a double acting, four way, five port, three position valve. When one solenoid is energized it can open one side of the valve 18, 18′ to send air into one port on the piston, while the air that is currently in the piston is pushed out through the other port on the cylinder 16, 16′ to the exhaust port on the valve 18, 18′ (see FIG. 10). In one embodiment, even in the event the solenoid is de-energized, the air is not removed from the cylinder 16, 16′, thus the window 10, 10′ does not move. When the second solenoid is energized, it can release air into the piston via the port that was previously used to vent the cylinder 16, 16′, and can push the cylinder 16, 16′ to the other direction (see FIGS. 9 and 10). The air that was in the piston can be vented to the atmosphere via the first port on the piston to the exhaust port on the valve 18, 18′.

Referring again to FIGS. 9 and 10, in one embodiment, the symbols shown on the two outer edges indicate the type of actuator activating the valve. In such an embodiment, Port “P” is the pressure input to the valve, when the left side is activated air is sent to port “A”, to port ‘Y’ in the cylinder, while the air in the cylinder is pushed out from port “Z”, returning to the valve's port “B” and exhausting to the atmosphere through port ‘S’. When the right side is activated air is sent to port “B” in the valve to the piston's port “Z”, and returned from the piston's port “Y’ (the opposite direction mentioned before) to port “A” in the valve, venting to the atmosphere through port “R”.

At least one power supply 20, 20′ can be operatively connected to each cylinder 16, 16′. For example, as shown in FIGS. 1, 3 and 7, one or more flexible hoses 23, 23′ can connect the power supply 20, 20′ to each cylinder 16, 16′. More particularly, one or more flexible hoses 23a, 23a′ can connect the power supply 20, 20′ to the valve(s) 18, 18′, and one or more flexible hoses 23b, 23b′ can connect the valve(s) 18, 18′ to the cylinders(s) 16, 16′. As an alternative to flexible hoses 23, 23′, rigid tubing, copper or PVC piping may be superior in certain situations. For example, building and fire codes can vary from one municipality to another regarding how compressed air should be piped. The power supply 20, 20′ can be spaced-apart from the window 10, 10′ or located at a predetermined distance away from the window 10, 10′. There can be several reasons to position the power supply 20, 20′ as described herein. For example, such positioning of the power supply 20, 20′ can reduce or eliminate any noise that may be produced by the power supply in the vicinity of the window 10, 10′. For example, the power supply 20, 20′ can be located in a closet, a basement or a garage. Further, such positioning of the power supply 20, 20′ can conserve space in the vicinity of the window 10, 10′. One or more flow valves 21, 21′ may be operatively connected to the at least one power supply 20, 20′.

The power supply 20, 20′ can include at least one compressor (e.g., an air compressor) and/or at least one pump, which can be electronically powered. The compressor or pump can deliver compressed or pressurized air to the cylinder(s) 16, 16′. Alternatively, the compressor or pump can deliver another fluid, such as a liquid, in pressurized form to the cylinder(s) 16, 16′. The supply or pressurized fluid to the cylinder(s) 16, 16′, as controlled by the at least one valve 18, 18′, can cause the piston to extend (at least slightly) from each cylinder 16, 16′, thereby (at least slightly) opening the window 10, 10′. In one embodiment, when the compressor or pump is “reversed” or turned off, the lower sash of the window 10 can close (e.g., due to gravity) or a vacuum can be created that pulls the piston within each cylinder 16, 16′, thereby causing the window 10, 10′ to at least partially close. Alternatively or additionally, as explained above, movement of the piston within each cylinder 16, 16′ can be bound to or controlled by the activation of the valves 18, 18′, whether open or closed.

At least one controller 22, 22′ or other computer processing device can be operatively connected to the at least one valve 18, 18′. Thus, the at least one controller 22, 22′ may not be connected directly to, but can at least be connected indirectly via at least one valve 18, 18′, the at least one power supply 20, 20′. The valve 18, 18′, cylinder(s) 16, 16′ and/or any sensors (such as those described below) can communicate with (e.g., wirelessly, such as through WiFi, Zigbee, Bluetooth, etc.) or be wired to the controller 22, 22′ regardless of the type of window used. The controller 22, 22′ can receive instructions from the individual (i.e., through a switch, push buttons, a touch screen (e.g., “Human Machine Interface” (HMI)), a smart device (e.g., smartphone, tablet computer), for example) and relay or convert those instructions to the valve 18, 18′, to thereby control operation of the cylinder(s) 16, 16′ and the opening and/or closing of the window 10, 10′. In one embodiment, a single touch to an “open” pushbutton can pulse like a momentary button to open the window. Alternatively, holding the “open” pushbutton can activate the window to open (or close) as long as the pushbutton is held or engaged. In one embodiment, when the push button, for example, is double clicked, the cylinder(s) 16, 16′ can open the window 10, 10′ completely or all the way.

One or more preset conditions can be programmed into the controller 22, 22′. The preset conditions can be any of a variety of features, such as opening each window only a predetermined amount, or closing certain windows but opening other windows, for example. The present conditions can be effectuated by the push of a button or the activation of a switch by the individual. In one embodiment, the controller 22, 22′ can be a programmable logic controller (“PLC”), which can be pre-programmed to read commands from a control panel or HMI. The control panel can optionally be remotely accessed via a wired or wireless remote control or “app” (e.g., such as that accessed by a smartphone) to open and/or close the window(s). The controller 22, 22′ can be programmed to open and/or close each or one or more of the windows based on one or more conditions, such as the date or time, indoor or outdoor weather (e.g., temperature, humidity, wind, rain, etc.) or when the buildings HVAC system is activated or deactivated. In one embodiment, air flow to the cylinder(s) 16, 16′ can be controlled by a set of the valve 18, 18′ based on a logic command from the PLC 22, 22′. In other words, the system can be controlled by a PLC-CPU that is configured or programmed to execute commands received from a logical side (e.g., push buttons and/or sensors) and sent to an output side (e.g., valve(s) 18, 18′).

The presently disclosed technology can include a safety apparatus configured to prevent injury and damage when the window closes. In one embodiment, the safety apparatus will not close the window, for example, if it detects an obstruction while the window is stationary in any position and/or while the window is moving. More particularly, at least one safety limit switch and/or at least one photoelectric sensor can each be configured to detect obstructions within a zone inside, near and/or around the window. Switches and/or sensors can be used to detect obstructions, such as an individual's hand, to thereby cause the window to open to avoid injuries. Alternatively or additionally, the switches and/or sensors can be used to stop the window from closing and/or open the window to avoid injuries. Each switch and sensor can be operatively connected to the controller 22, 22′ to allow the controller 22, 22′ to make a corresponding change in position or orientation of the cylinders(s) 16, 16′, if necessary or desirable. For example, as shown in FIGS. 1 and 3-5, one or more safety limit switches 24, 24′ or photoelectric sensors 26, 26′ can be located on or near the casing 12, 12′ of the window 10, 10′. More particularly, opposing switches 24, 24′ or sensors 26, 26′ can be located on opposing sides of the casing 12, 12′ and sense when an object extends in between.

In one embodiment, the system of the present disclosure can include a “lock-in feature,” so that the user can raise or lower the window-sash in pre-set gradations. In addition or alternatively, the controller 22, 22′ can be set or programmed to open or close windows at given times, such as opening the windows at night and closing them during the day, or vice-versa. With the smartphone app, the user can use the system of the present disclosure to close and/or open windows at home, for example, from wherever they might be at the moment, such as at work, while a thunderstorm approaches their neighborhood.

The system of the present disclosure offers a solution with a simple, but important, benefit to consumers: the ability to open or close windows at the press of a button. Windows are often difficult to access and require that individuals stand or kneel on couches or beds, lean and reach over tables and desks, and similarly contort themselves to just access the window. Then, individuals are often required to strain to get the window(s) opened or closed. This inaccessibility is an inconvenience and an annoyance to anyone; but when the individual in question is elderly or disabled, the opening and closing of windows can become particularly difficult. The system of the present disclosure makes it possible for anyone to quickly and effortlessly raise and lower windows to achieve the level of comfort and ventilation that they desire. Further, because the system of the present disclosure can operate quickly and easily, the system is ideal for such settings as nursing homes and assisted-living facilities, where the health-care staff can employ the system on their rounds to immediately accommodate a patient or resident's wishes. The system of the present disclosure thus meet the needs of general consumer households who seek greater ease and convenience, as well as the more pressing needs of the elderly and handicapped or disabled who find it difficult if not impossible to raise and lower windows without assistance.

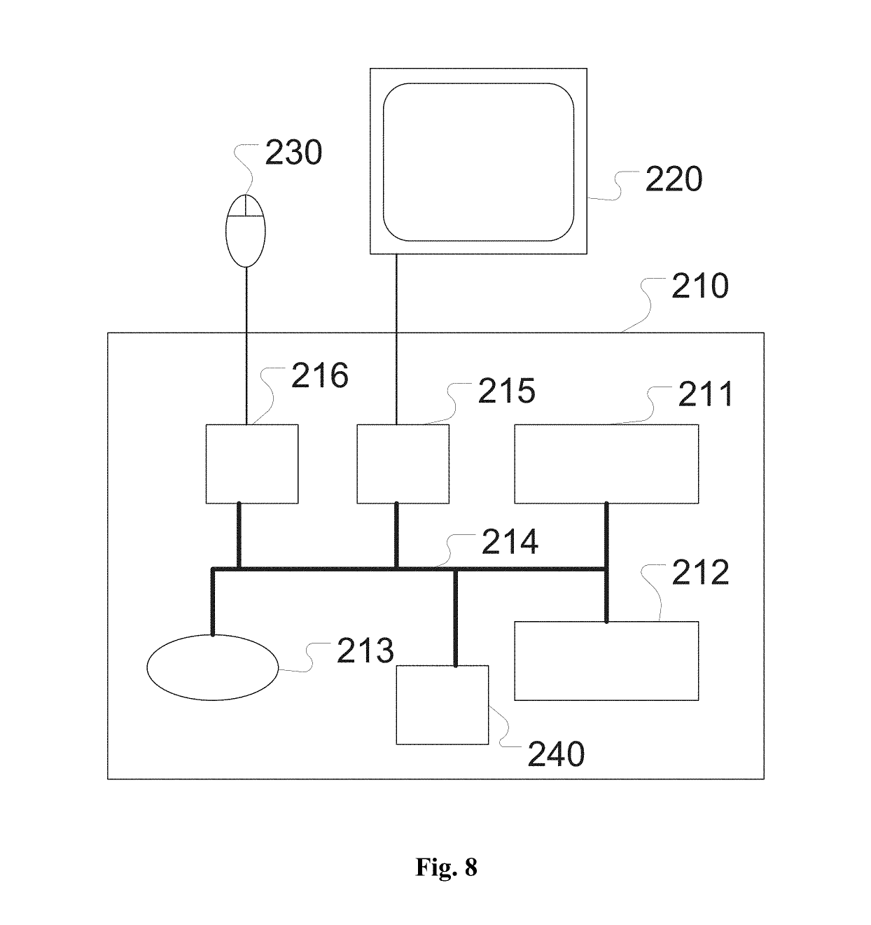

One or more of the above-described techniques and/or embodiments may be implemented with or involve software, for example modules executed on one or more computing devices 210 (see FIG. 8). Of course, modules described herein illustrate various functionalities and do not limit the structure or functionality of any embodiments. Rather, the functionality of various modules may be divided differently and performed by more or fewer modules according to various design considerations.

Each computing device 210 may include one or more processing devices 211 designed to process instructions, for example computer readable instructions (i.e., code), stored in a non-transient manner on one or more storage devices 213. By processing instructions, the processing device(s) 211 may perform one or more of the steps and/or functions disclosed herein. Each processing device may be real or virtual. In a multi-processing system, multiple processing units may execute computer-executable instructions to increase processing power. The storage device(s) 213 may be any type of non-transitory storage device (e.g., an optical storage device, a magnetic storage device, a solid state storage device, etc. The storage device(s) 213 may be removable or non-removable, and may include magnetic disks, magneto-optical disks, magnetic tapes or cassettes, CD-ROMs, CD-RWs, DVDs, BDs, SSDs, or any other medium which can be used to store information. Alternatively, instructions may be stored in one or more remote storage devices, for example storage devices accessed over a network or the internet.

Each computing device 210 additionally may have memory 212, one or more input controllers 216, one or more output controllers 215, and/or one or more communication connections 240. The memory 212 may be volatile memory (e.g., registers, cache, RAM, etc.), non-volatile memory (e.g., ROM, EEPROM, flash memory, etc.), or some combination thereof. In at least one embodiment, the memory 212 may store software implementing described techniques.

An interconnection mechanism 214, such as a bus, controller or network, may operatively couple components of the computing device 210, including the processor(s) 211, the memory 212, the storage device(s) 213, the input controller(s) 216, the output controller(s) 215, the communication connection(s) 240, and any other devices (e.g., network controllers, sound controllers, etc.). The output controller(s) 215 may be operatively coupled (e.g., via a wired or wireless connection) to one or more output devices 220 (e.g., a monitor, a television, a mobile device screen, a touch-display, a printer, a speaker, etc.) in such a fashion that the output controller(s) 215 can transform the output device(s) 220 (e.g., in response to modules executed). The input controller(s) 216 may be operatively coupled (e.g., via a wired or wireless connection) to an input device 230 (e.g., a mouse, a keyboard, a touch-pad, a scroll-ball, a touch-display, a pen, a game controller, a voice input device, a scanning device, a digital camera, etc.) in such a fashion that input can be received from a user.

The communication connection(s) 240 may enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

FIG. 8 illustrates the computing device 210, the output device 220, and the input device 230 as separate devices for ease of identification only. However, the computing device 210, the display device(s) 220, and/or the input device(s) 230 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). The computing device 210 may be one or more servers, for example a farm of networked servers, a clustered server environment, or cloud services running on remote computing devices.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system configured to move at least a portion of a window, the window being positioned within a casing mounted in an opening of a wall, the system comprising:
two spaced-apart actuators, each actuator including a cylinder having a piston, the piston being movable with respect to the cylinder, the cylinder being at least partially concealed within at least one of the casing and the wall proximate the window, each cylinder having a longitudinal axis extending parallel to sidewalls of the window;
at least one solenoid valve operatively connected to each actuator;
at least one power supply operatively connected to the at least one solenoid valve, the power supply being spaced-apart from the window to eliminate or at least reduce noise produced by the power supply in a vicinity of the window;
at least one controller operatively connected to the at least one solenoid valve, the controller being configured to control operation of at least the valve to thereby control operation of the actuator to move at least a portion of the window; and
at least one safety limit switch and at least one photoelectric sensor, the safety limit switch and the photoelectric sensor being configured to detect obstructions within a zone inside the window.

2. The system of claim 1, wherein each piston is one of a pneumatic piston and a hydraulic piston.

3. The system of claim 2, wherein the power supply is one of a compressor and a pump.

4. The system of claim 3, wherein at least one of flexible hose, rigid tubing, copper piping or polyvinyl chloride (PVC) piping connects the power supply to each cylinder.

5. The system of claim 3, wherein when the power supply is activated, the pistons open the window, and wherein when the power supply is turned off, the window closes.

6. A system configured to move at least a portion of a window, the window being positioned within a casing mounted in an opening of a wall, the system comprising:
at least one actuator;
at least one valve operatively connected to the actuator;
at least one power supply operatively connected to the at least one valve, the power supply being spaced-apart from the window to eliminate or at least reduce noise produced by the power supply in a vicinity of the window; and
at least one controller operatively connected to the at least one valve, the controller being configured to control operation of at least the valve to thereby control operation of the actuator to move at least a portion of the window.

7. The system of claim 6, wherein the at least one actuator is a cylinder including a piston, the piston being movable with respect to the cylinder, the cylinder being at least partially concealed within at least one of the wall proximate the window and the casing.

8. The system of claim 6, wherein the at least one valve is a solenoid valve.

9. The system of claim 7, further comprising:
two spaced-apart cylinders, each cylinder including a piston, each cylinder having a longitudinal axis extending parallel to sidewalls of the window.

10. The system of claim 7, wherein the piston is one of a pneumatic piston and a hydraulic piston.

11. The system of claim 10, wherein the power supply is one of a compressor and a pump.

12. The system of claim 6, further comprising:
at least one safety limit switch and at least one photoelectric sensor, the safety limit switch and the photoelectric sensor being configured to detect obstructions within a zone inside the window.

13. The system of claim 7, wherein at least one of flexible hose, rigid tubing, copper piping or polyvinyl chloride (PVC) piping connects the power supply to the cylinder.

14. The system of claim 7, wherein when the power supply is activated, the piston opens the window.

15. The system of claim 14, wherein when the power supply is turned off, the window closes.

16. The system of claim 14, wherein when the power supply is activated, the window closes.

17. The system of claim 7, wherein the cylinder is completely concealed within at least one of the walls proximate to the window and the casing.

18. The system of claim 7, wherein the cylinder is at least partially concealed within at least one of the walls proximate to the window and the casing.

19. A system configured to move at least a portion of a window, the window being positioned within a casing mounted in an opening of a wall, the system comprising:
at least one actuator including a cylinder having a piston, the piston being movable with respect to the cylinder, the cylinder being at least partially concealed within at least one of the wall proximate the window and the casing;
at least one electromechanically-operated valve operatively connected to the actuator;
at least one power supply operatively connected to the at least one electromechanically-operated valve, the power supply being spaced-apart from the window to eliminate or at least reduce noise produced by the power supply in a vicinity of the window; and
at least one controller operatively connected to the at least one electromechanically-operated valve, the controller being configured to control operation of at least the valve to thereby control operation of the actuator to move at least a portion of the window.

20. The system of claim 19, further comprising:
at least one safety limit switch and at least one photoelectric sensor, the safety limit switch and the photoelectric sensor being configured to detect obstructions within a zone inside the window.
